(19) United States
(12) Patent Application Publication
(10) Pub. No.: US 2004/0078324 A1
(43) Pub. Date: Apr. 22, 2004

(54) Systems and methods for authenticating a financial account at activation

(76) Inventors: Carl Lonnberg, Bethesda, MD (US); John Polk, Richmond, VA (US)

Correspondence Address: Finnegan, Henderson, Farabow,, Garrett & Dunner, L.L.P., 1300 I Street, N.W., Washington, DC, 20005-3315, US

(21) Appl. No.: 10/270,554

(22) Filed: Oct. 16, 2002

(51) Int. Cl. G06F 17/60

(52) U.S. Cl. 705/39

(57) ABSTRACT

Financial account issuer activates a financial account by determining whether the financial should be flagged for applicant authentication. Financial account issuer issues the financial account. Upon receipt of an activation request to activate the financial account, issuer determines whether the financial account has been flagged for applicant authentication. If the financial account has been flagged for applicant authentication, issuer initiates an applicant authentication process.

### FIELD OF THE INVENTION

The present invention relates generally to systems and methods for activating a financial account and more specifically to systems and methods for authenticating an applicant's identity during activation of the financial account.

### BACKGROUND OF THE INVENTION

Financial account issuers have developed a variety of measures to prevent persons from fraudulently activating financial accounts. Unfortunately, these measures often result in denying a financial account to a legitimate applicant. For example, FIG. 1 illustrates a conventional method 100 for activating a credit card. At stage 110, the financial account issuer receives a credit card application submitted by an applicant.

At stage 120, the issuer determines whether to authenticate or confirm the applicant's identity. If the issuer decides not to authenticate the applicant's identity (i.e., “No” at stage 120), then the issuer issues the credit card to the applicant. If the issuer decides to authenticate the applicant's identity (i.e., “Yes” at stage 120), then the issuer initiates an applicant authentication process at stage 130. This involves contacting the applicant to ask the applicant one or more questions to confirm the applicant's identity. If the issuer cannot contact the applicant (i.e., “No” at stage 135), then the issuer denies the application at stage 150. If the issuer contacts the applicant (i.e., “Yes” at stage 135), then the issuer proceeds to ask the applicant one or more questions.

At stage 140, the issuer determines whether the applicant's identity has been authenticated based on applicant's responses to the one or more questions asked by the issuer. If the applicant's identity is not authenticated (i.e., “No” at stage 140), then the-issuer denies the application at stage 150. If the applicant's identity is authenticated (i.e., “Yes” at stage 140), then the issuer issues the credit card to the applicant at stage 160.

As shown by FIG. 1, one problem with the conventional method 100 is that the issuer often denies applications because the issuer could not contact the applicant. As a result, the issuer may likely decline applications at stage 150 that it would have approved if it had contacted the applicant. The financial account issuer thus loses a substantial amount of revenue by not issuing credit card accounts to these valid customers. Accordingly, there is a need for systems and methods for preventing fraud while reducing the number of denials of legitimate financial account applications.

### SUMMARY OF THE INVENTION

In accordance with the invention, there is provided a method for activating a financial account applied for by a customer. There is also provided a computer readable medium containing instructions for controlling a computer system to perform a method for activating a financial account applied for by a customer. The method comprises flagging the financial account based on a determination that identification of the customer must be authenticated and issuing the financial account to the customer. The method further comprises receiving a request to activate the financial account and determining that the financial account corresponding to the activation request has been flagged. If the financial account has been flagged for applicant authentication, an applicant authentication process is initiated.

There is also provided a computer for activating a financial account applied for by a customer, wherein the financial account is issued prior to customer authentication. The computer comprises a memory having program instructions; and a processor, responsive to the programming instructions, configured to flag the financial account based on a determination that identification of the customer must be authenticated; receive a request to activate the financial account; determine that the financial account corresponding to the activation request has been flagged; and initiate a process for authenticating the customer's identification based on a determination that the account has been flagged.

There is further provided a system for activating a financial account. The system comprises means for flagging the financial account based on a determination that identification of the customer must be authenticated, means for receiving a request to activate the financial account, means for determining that the financial account corresponding to the activation request has been flagged, and means for initiating a process for authenticating the customer's identification based on a determination that the account has been flagged.

Both the foregoing general description and the following detailed description are exemplary and explanatory only and are intended to provide further explanation of the invention as claimed.

### BRIEF DESCRIPTION OF THE DRAWINGS

The accompanying drawings provide a further understanding of the invention and, together with the detailed description, serve to explain the principles of the invention. In the drawings:

FIG. 1 is a flow diagram illustrating a conventional method for activating a credit card;

FIG. 2 illustrates an exemplary environment, consistent with the present invention, for activating credit cards;

FIG. 3 is a flow diagram illustrating an exemplary method, consistent with the present invention, for activating a financial account; and

FIG. 4 illustrates advantages of the present invention over the conventional method of activating a financial account.

### DESCRIPTION OF THE EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

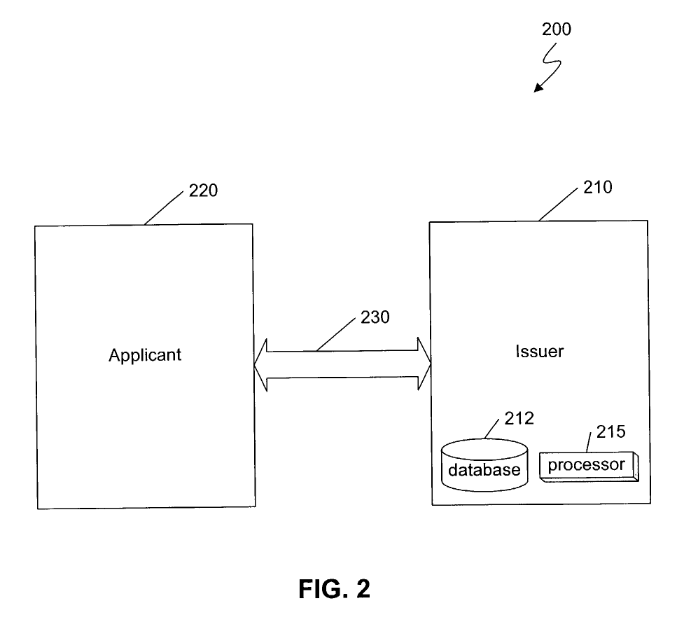

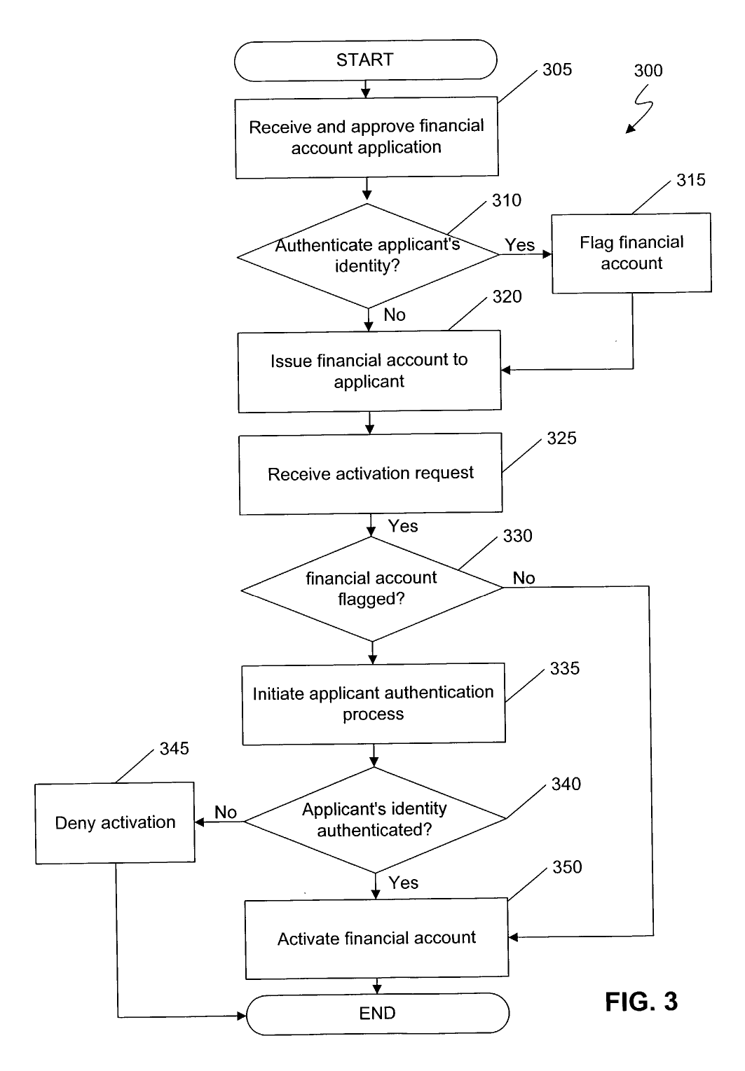

FIG. 2 illustrates an exemplary environment 200 consistent with the present invention for activating financial accounts, for example credit cards, debit cards, prepaid cards, checking accounts, or any other financial account. Environment 200 comprises a financial account issuer 210 and one or more account applicants 220. Issuer 210 may include a customer account database 212 (or other storage medium), which may store information related to accounts issued by issuer 210. For example, database 212 may include account numbers, applicant information, or flags (discussed in greater detail below). Issuer 210 may also include a processor 215 comprising computer instructions for implementing methods consistent with the present invention described in further detail below with respect to FIG. 3.

Issuer 210 and applicant 220 may communicate via link 230, via mail, in person, or a combination of the foregoing. Communication link 230 may be any system, network, or device that facilitates communication (e.g., data communication or telecommunication) using any appropriate communication protocol (e.g., TCP/IP, HTTP, HTTPS or any other security protocol, FTP, SMTP, or any other proprietary protocol). Communication link 230 may comprise a local area network (LAN) connection, a wide area network (WAN) connection, an Internet connection, or a combination of the foregoing. Communication link 230 may comprise a telephone line, optical fiber, coaxial cable, twisted wire pair, or a combination of the foregoing. Communication link 230 may be wireless using any appropriate technique to provide wireless transmission including infrared line of sight, cellular, microwave, satellite, packet radio, spread spectrum, or a combination of the foregoing. For example, applicant 220 may submit an account application to issuer 210 via the Internet, via the mail, over the telephone, or in person by visiting the issuer 210. Applicant may also communicate with issuer 210 to activate an account via the Internet, via the mail, over the telephone, or in person by visiting issuer 210.

FIG. 3 illustrates an exemplary method 300 for activating a financial account consistent with the present invention. At stage 305, issuer 210 may receive and approve a financial account application submitted by applicant 220. At stage 310, issuer 210 determines whether applicant's 220 identity must be authenticated. In systems consistent with the present invention, issuer 210 may use fraud detection techniques well known in the art for determining whether an application for a financial account exceeds a threshold level of risk. As known in the art, the threshold level of risk may be based on information obtained from a negative file (e.g. a file identifying high risk persons, such as those who have filed for bankruptcy or who have been linked to a fraudulent activity), third party credit information (e.g., a credit reporting agency or vendor), customer risk profiles, velocity indicators (e.g., the frequency with which a particular person submits an application), application information (or the lack thereof) provided in the financial account application, or a combination of the foregoing.

For example, if a name or other identifying information (e.g., a person's Social Security Number) provided in a financial account application is included in a negative file, then issuer 210 may determine to authenticate that applicant's 220 identity. As another example, issuer 210 may determine to authenticate applicant's 220 identity if multiple applications have been submitted in the name of one person. As yet another example, if information submitted on an application is inconsistent with information obtained from a credit reporting agency, issuer 210 may determine to authenticate applicant's 220 identity. Also, if information submitted on an application is missing, illegible, or corresponds to a high risk applicant profile, then issuer 210 may determine to authenticate applicant's 220 identity. Persons skilled in the art understand, however, that the above authentication determinations are simply explanatory and that other known fraud detection techniques may be used to determine whether to authenticate an applicant's identity.

Stage 310 may be carried out by one or more persons, one or more processors 215, or a combination of the foregoing. Further, while the above exemplary embodiment determines whether to authenticate an applicant on an application-by-application basis, processor 215 may use other methods as well. For instance, processor 215 may determine to authenticate applicant's 220 identity on a random basis.

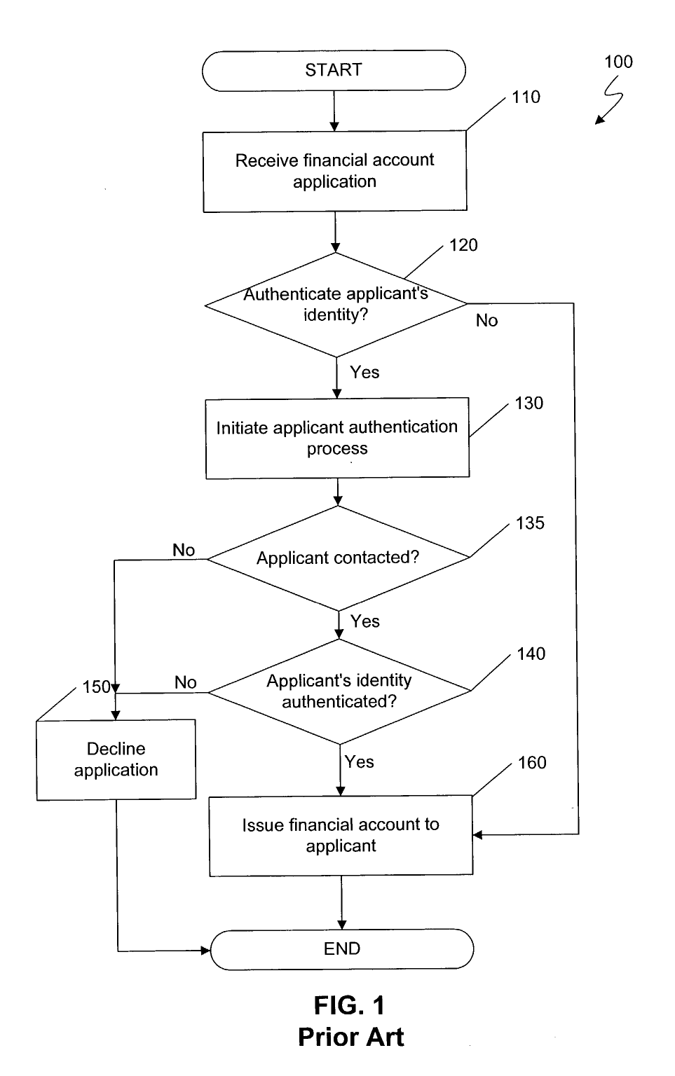

If issuer 210 decides to authenticate applicant's 220 identity (i.e., “Yes” at stage 310), then issuer 210 may flag the financial account for applicant authentication at stage 315. Issuer 210 may flag the financial account by storing in database 212 a financial account identifier for the financial account (e.g., an account number) and a notation that the financial account requires applicant authentication prior to activation. After the financial account has been flagged, issuer 210 may issue the financial account to applicant 220 at stage 320. Accordingly, in contrast to the conventional method 200 of FIG. 1, issuer 210 may issue a financial account that has been flagged for applicant authentication without authenticating applicant's 220 identity. Stage 315 may be carried out by one or more persons, one or more processors 215, or a combination of the foregoing.

If issuer 210 decides that applicant's 220 identity does not need to be authenticated (i.e., “No” at stage 310), then issuer 210 issues the financial account to applicant 220 at stage 320. All accounts issued to applicants as part of step 320 may be accompanied by a notification that the account must be activated. For example, the account may be a credit card that is sent to the applicant with a notification (e.g., a sticker on the card) that the applicant must call issuer 210 to activate the card. Systems consistent with the invention may use any of a number of known techniques to notify the applicant of the required activation process. In this respect, the notification may accompany the account when it is issued to the customer or may be forwarded separately to the applicant.

When issuer 210 later receives an activation request at stage 325, issuer 210 determines whether the financial account associated with that request is flagged for applicant authentication at stage 330. Issuer 210 may make this determination by retrieving information stored in database 212 based on a financial account identifier supplied during the activation request at stage 325. For example, the activation request may identify the particular account or applicant associated with that request. Issuer 210 may then access database 212 to determine whether an authentication flag has been set for that particular account or applicant. Stage 330 may be carried out by one or more persons, one or more processors 215, or a combination of the foregoing.

If the financial account has not been flagged for applicant authentication (i.e., “No” at stage 330), then issuer 210 may activate the financial account at stage 350. However, prior to activation, issuer 210 may require the requester to confirm standard information associated with the financial product, such as an address or a part thereof (e.g., a ZIP code) or an account number, phone number, or a social security number or a part thereof.

However, if the financial account has been flagged for applicant authentication (i.e., “Yes” at stage 330), then issuer 210 may initiate an applicant authentication process at stage 335. The applicant authentication process may comprise asking the person requesting activation one of more questions to confirm that person's identity. For example, issuer 210 may require additional information that may not have been provided on the financial account application. During the applicant authentication process, issuer 210 may ask one or more questions designed to identify a fraudulent applicant. For example, issuer 210 may ask one or more questions that a fraudulent applicant attempting to use another person's identity may not know, such as information that is not contained on the application, but that is known to issuer 210, a previous address of the applicant, the applicant's maiden name or mother's maiden name, etc. Methods for authenticating an applicant's identity are known to those of ordinary skill in the art. Stages 335 and 350 may be carried out by one or more persons, one or more processors 215, or a combination of the foregoing.

At stage 340, issuer 210 determines whether applicant's 220 identity has been authenticated. If applicant's 220 identity is not authenticated (i.e., “No” at stage 340), then issuer 210 denies activation of the financial account at stage 345. Applicant's 220 identity may not be authenticated at stage 340 because one or more questions were not answered or answered incorrectly during the applicant authentication process at stage 335. If applicant's 220 identity is authenticated (i.e., “Yes” at stage 340), then the financial account is activated at stage 350. Stages 340, 345 may be carried out by one or more persons, one or more processors 215, or a combination of the foregoing.

An exemplary embodiment consistent with the present invention may be implemented using a voice response unit (VRU). For example, issuer 210 may require financial accounts to be activated over the telephone via an automated process implemented by a VRU. In this case, as part of an activation request, the requester enters information about the account (e.g., the account number) into the VRU. At this point, as part of step 330, processor 215 may then determine whether the account has been flagged for an authentication process. If the account has not been flagged, then the VRU may apply a conventional process in which the applicant is required to provide some basic information (e.g., last four digits of the applicant's Social Security Number) in order to have the account activated. If the account has been flagged, then processor 215 may automatically forward the requester to a customer service representative who may then speak with the requester to confirm the applicant's identity, as described above with respect to stage 335. Alternatively, the VRU may automatically implement this authentication process, such that processor 215 automatically analyzes the requester's responses to determine whether that person's identity has been authenticated.

While the above example has been described with respect to a VRU, systems consistent with the invention may implement the activation process in other ways as well. For instance, the requester may contact issuer 210 via the Internet such that the activation procedure is implemented through a web page. Alternatively, the requester may initiate the activation process in person by visiting issuer 210.

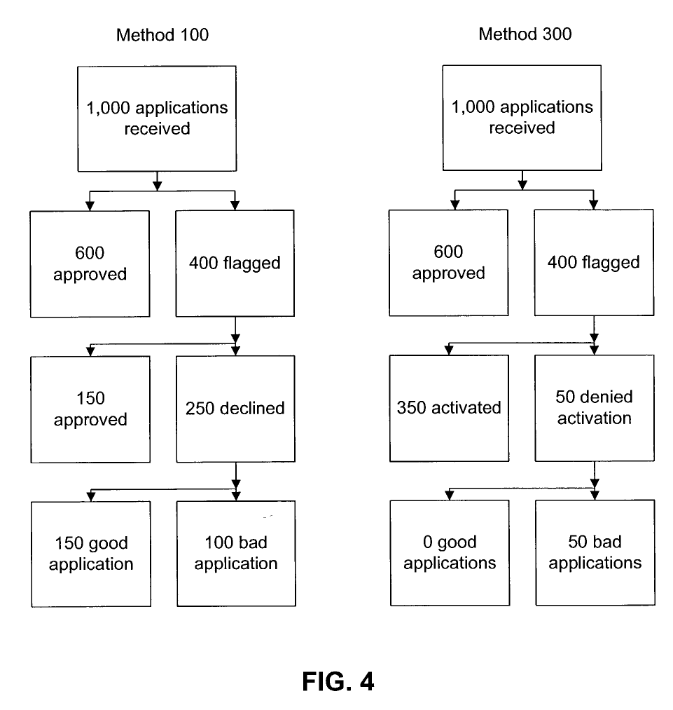

FIG. 4 illustrates at least one advantage of the present invention over the conventional method 200 of activating a credit card. The numbers used in FIG. 4 are exemplary and used for explanatory purposes. Using the conventional method 200, an issuer may receive 1,000 applications, approving 600 of those for issuance and setting aside the remaining 400 for applicant authentication. Out of the 400 applications set aside for applicant authentication, the issuer may end up declining 250 of those applications as potentially fraudulent accounts and approving the remaining 150 for issuance. Out of the 250 applications declined, 150 applications may have been declined because the issuer 210 was unable to contact the applicants. These 150 applications may have been approved if the issuer could have contacted the applicant.

In contrast, by using the systems and methods of the present invention, instead of setting aside the 400 credit cards for applicant authentication, issuer 210 may send out all 400 inactive credit cards prior to applicant authentication and perform applicant authentication when a request is received to activate the credit cards. In this way, no application is declined because the issuer 210 could not contact the applicant. Accordingly, out of the 400 applications flagged for applicant authentication, issuer 210 may only decline 50 applications (compared to 250 applications declined using the conventional method 200) and approve 350 applications (compared to 150 applications approved using the conventional method 200). Of the 50 applications declined using the systems and methods of the present invention, none of the applications may be declined because issuer 210 could not reach the applicant. Thus, the 150 “good” applications in the above example that were declined by the conventional method 200, may be approved by using the systems and method of the present invention.

Systems and methods consistent with the present invention may be used for a number of financial accounts, such as credit card accounts, debit card accounts, prepaid card accounts, checking accounts, or any other financial account.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for activating a financial account applied for by a customer, comprising:
flagging the financial account based on a determination that identification of the customer must be authenticated;
issuing the financial account to the customer;
receiving a request to activate the financial account;
determining that the financial account corresponding to the activation request has been flagged; and
initiating a process for authenticating the customer's identification based on a determination that the account has been flagged.

2. The method of claim 1, wherein flagging the financial account further includes:
flagging the financial account based on a determination that a predetermined fraud risk criteria is exceeded.

3. The method of claim 2, wherein the predetermined fraud risk criteria is used to identify customers that have fraudulently applied for a financial account.

4. The method of claim 1, wherein a plurality of financial accounts are issued to corresponding customers, and wherein the flagging further comprises:
identifying a subset of the plurality of financial accounts to flag for authentication.

5. The method of claim 4, wherein identifying a subset of the plurality of financial accounts to flag for authentication further includes:
identifying a subset of the plurality of financial accounts to flag based on a determination that a predetermined fraud risk criteria is exceeded for each of the subset of financial products.

6. The method of claim 5, wherein each customer submits an application to apply for a financial account, the method further comprising:
activating an unflagged financial account by receiving, as part of an activation request, customer information included on the application submitted by that customer.

7. The method of claim 1, wherein the customer submits an application to apply for the financial account, and wherein initiating the authentication process further includes requesting customer information other than that included on the submitted application.

8. The method of claim 1, further including:
activating the financial account when the customer's identification has been authenticated.

9. A method for activating a financial account applied for by a customer, comprising:
receiving the financial account, wherein the financial account is flagged for customer authentication;
requesting activation of the financial account; and
providing information during a customer authentication process.

10. A computer for activating a financial account applied for by a customer, wherein the financial account is issued prior to customer authentication, the computer comprising:
a memory having program instructions; and
a processor, responsive to the programming instructions, configured to:
flag the financial account based on a determination that identification of the customer must be authenticated;
receive a request to activate the financial account;
determine that the financial account corresponding to the activation request has been flagged; and
initiate a process for authenticating the customer's identification based on a determination that the account has been flagged.

11. The computer of claim 10, wherein the processor is configured to flag the financial account based on a determination that a predetermined fraud risk criteria is exceeded.

12. The computer of claim 11, wherein the predetermined fraud risk criteria is used to identify customers that have fraudulently applied for a financial account.

13. The computer of claim 10, wherein a plurality of financial accounts are issued to corresponding customers, and wherein the processor is configured to identify a subset of the plurality of financial accounts to flag for authentication.

14. The computer of claim 13, wherein the processor is configured to identifying a subset of the plurality of financial accounts to flag based on a determination that a predetermined fraud risk criteria is exceeded for each of the subset of financial products.

15. The computer of claim 14, wherein each customer submits an application to apply for a financial account and wherein the processor is further configured to activate an unflagged financial account by receiving, as part of an activation request, customer information included on the application submitted by that customer.

16. The computer of claim 10, wherein the customer submits an application to apply for the financial account, and wherein the processor is configured to initiate the authentication process by at least requesting customer information other than that included on the submitted application.

17. The computer of claim 10, wherein the processor is further configured to activate the financial account when the customer's identification has been authenticated.

18. A system for activating a financial account applied for by a customer, wherein the financial account is issued prior to applicant authentication, comprising:
means for flagging the financial account based on a determination that identification of the customer must be authenticated;
means for issuing the financial account to the customer;
means for receiving a request to activate the financial account;
means for determining that the financial account corresponding to the activation request has been flagged; and
means for initiating a process for authenticating the customer's identification based on a determination that the account has been flagged.

19. The system of claim 18, means for flagging the financial account includes means for flagging the financial account based on a determination that a predetermined fraud risk criteria is exceeded.

20. The system of claim 18, wherein the predetermined fraud risk criteria is used to predict customers that may have fraudulently applied for a financial account.

21. The system of claim 18, wherein a plurality of financial accounts are issued to corresponding customers, and wherein the means for flagging comprises means for identifying a subset of the plurality of financial accounts to flag for authentication.

22. The system of claim 21, wherein means for identifying a subset of the plurality of financial accounts to flag for authentication comprises means for identifying a subset of the plurality of financial accounts to flag based on a determination that a predetermined fraud risk criteria is exceeded for each of the subset of financial products.

23. The system of claim 22, wherein each customer submits an application to apply for a financial account, the system further comprising:
means for activating an unflagged financial account by receiving, as part of an activation request, customer information included on the application submitted by that customer.

24. The system of claim 18, wherein the customer submits an application to apply for the financial account, and wherein means for initiating the authentication process comprises means for requesting customer information other than that included on the submitted application.

25. The system of claim 18 further comprising:
means for activating the financial account when the customer's identification has been authenticated.
